(19) United States
(12) Patent Application Publication
(10) Pub. No.: US 2013/0101271 A1
(43) Pub. Date: Apr. 25, 2013

(54) VIDEO PROCESSING APPARATUS AND METHOD

(71) Applicant: Fujitsu Limited, Kawasaki-shi (JP)

(72) Inventor: Masashi URUSHIHARA, Kawasaki (JP)

(73) Assignee: FUJITSU LIMITED, Kawasaki-shi (JP)

(21) Appl. No.: 13/715,344

(22) Filed: Dec. 14, 2012

Related U.S. Application Data
(63) Continuation of application No. PCT/JP2010/060860, filed on Jun. 25, 2010.

(51) Int. Cl. H04N 5/00

(52) U.S. Cl. CPC H04N 5/00
USPC 386/248

(57) ABSTRACT

A video processing apparatus is disclosed. An acquisition part acquires category information of video data of a process target. A storage part stores each set of category information by associating extraction information indicating a location in a portion of the video data. A creation part specifies a location used for thumbnail data from the video data of the process target based on the extraction information, which is stored in the storage part and corresponds to the category information acquired by the acquisition part.

### CROSS-REFERENCE TO RELATED APPLICATIONS

This application is a continuation application of International Application PCT/JP2010/060860 filed on Jun. 25, 2010 and designated the U.S., the entire contents of which are incorporated herein by reference.

### FIELD

The embodiment discussed herein is related to a video processing apparatus and method for processing video data.

### BACKGROUND

In general, a recoding and reproducing apparatus acquires and displays a beginning portion of recorded data as thumbnail data of a recorded program. Thus, there is an advertisement (hereinafter, called “AD”) when recording is started. When an image irrelevant to a main story, which a user wishes to record, is broadcasted, a scene irrelevant to the main story is displayed as the thumbnail data. Accordingly, in order to extract thumbnail data properly for the user, various methods for extracting the thumbnail data are presented.

There is a technology for displaying frame video information including a character string included in program title information as a thumbnail.

Moreover, in another technology, content data are supplied to an AD detection part, and a second signal section from the beginning or a signal section which does not include a specific feature is regarded as a main story section after multiple signal sections are identified. Then, the thumbnail data are created from the main story section.

### PATENT DOCUMENTS

Japanese Laid-open Patent Publication No. 2006-140603
Japanese Laid-open Patent Publication No. 2004-147204

### SUMMARY

According to one aspect of the embodiment, there is provided a video processing apparatus, including an acquisition part configured to acquire category information of video data of a process target; a storage part configured to store each set of category information by associating with extraction information indicating a location in a portion of the video data; and a creation part configured to specify a location used for thumbnail data from the video data of the process target based on the extraction information, which is stored in the storage part and corresponds to the category information acquired by the acquisition part.

According to another aspect of the embodiment, there is provided a video processing method performed in a video processing apparatus including a computer and a storage part, the method including: acquiring, by the computer, the category information of video data of a process target; and specifying, by the computer, a location used for the thumbnail data from the video data of the process target based on the extraction information corresponding to the category information which is acquired from the extraction information indicating a location in a portion of the video data stored in the storage part by associating with the category information of the video data.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 is a block diagram illustrating an example of hardware of a video processing apparatus;

FIG. 2 is a block diagram illustrating an example of a functional configuration of the video processing apparatus in a first embodiment;

FIG. 3 is a diagram illustrating an example of video information;

FIG. 4 is a diagram illustrating an example of general configuration information of the video data;

FIG. 5 is a diagram illustrating an example of extraction information;

FIG. 6 is a block diagram illustrating an example of a functional configuration of a video data analysis part;

FIG. 7 is a diagram illustrating an example of a scene extracted as thumbnail data;

FIG. 8 is a diagram illustrating an example of analysis result information of the video data stored in a storage part;

FIG. 9 is a diagram illustrating an example of a screen which displays a recorded television program list;

FIG. 10 is a flowchart for explaining an example of an analysis process conducted by the video data analysis part;

FIG. 11 is a flowchart for explaining an example of a creation process of the thumbnail data;

FIG. 12 is a flowchart for explaining an example of an extraction process of the thumbnail data;

FIG. 13 is a block diagram illustrating an example of a functional configuration of a video processing apparatus in a second embodiment;

FIG. 14 is a diagram illustrating extraction information in the second embodiment;

FIG. 15 is a diagram illustrating examples of thumbnail candidates;

FIG. 16 is a diagram illustrating examples of a video analysis result and the thumbnail candidates;

FIG. 17 is a diagram illustrating an example of a selection screen of the thumbnail candidates;

FIG. 18 is a flowchart for explaining examples of a video analysis process and a thumbnail candidate extraction process in the second embodiment;

FIG. 19 is a block diagram illustrating an example of a functional configuration of a video processing apparatus in a third embodiment;

FIG. 20 is a diagram illustrating an example of a selection screen of thumbnail candidates;

FIG. 21 is a diagram illustrating an example of thumbnail data extracted in a third embodiment;

FIG. 22 is a flowchart for explaining an example of a thumbnail selection process in the third embodiment;

FIG. 23 is a flowchart for explaining an example of a thumbnail extraction process in the third embodiment; and

FIG. 24 is a diagram illustrating an example of a data structure of an Electronic Program Guide.

### DESCRIPTION OF EMBODIMENTS

In the following, embodiments of the present invention will be described with reference to the accompanying drawings. In the embodiment, as a video processing apparatus, a recording and reproducing apparatus with a television tuner will be illustrated. However, the embodiment is not limited to the recording and reproducing apparatus, and may be applied to a recording apparatus for recording and processing video data. Also, the video processing apparatus may be an information processing apparatus including a configuration for acquiring and processing the video data, a receiver of a television including a configuration for recording a received video data, or the like.

In a case of extracting the thumbnail data in related arts, the content configuration of the video data is not considered. However, a content configuration of video data may be defined depending on a type (category) of a program. In a case in which the category of the video data is the “MUSIC”, the video data may be generally formed in an order of “AD”, “COMMENTARY”, “AD”, “MUSIC”, “AD”, “MUSIC”, and the like. In a case in which the category of the video data is “CARTOON” OR “DRAMA”, the video data may be generally formed in an order of “AD”, “THEME SONG”, “MAIN PROGRAM (FIRST HALF)”, “AD”, “MAIN PROGRAM (LAST HALF)”, and the like. Depending on a different category of the video data, the thumbnail data suitable for a user may be changed.

In each of the embodiments described below, the video processing apparatus is provided in which the thumbnail data suitable for the user is created depending on the category of the video data.

### FIRST EMBODIMENT

### Hardware

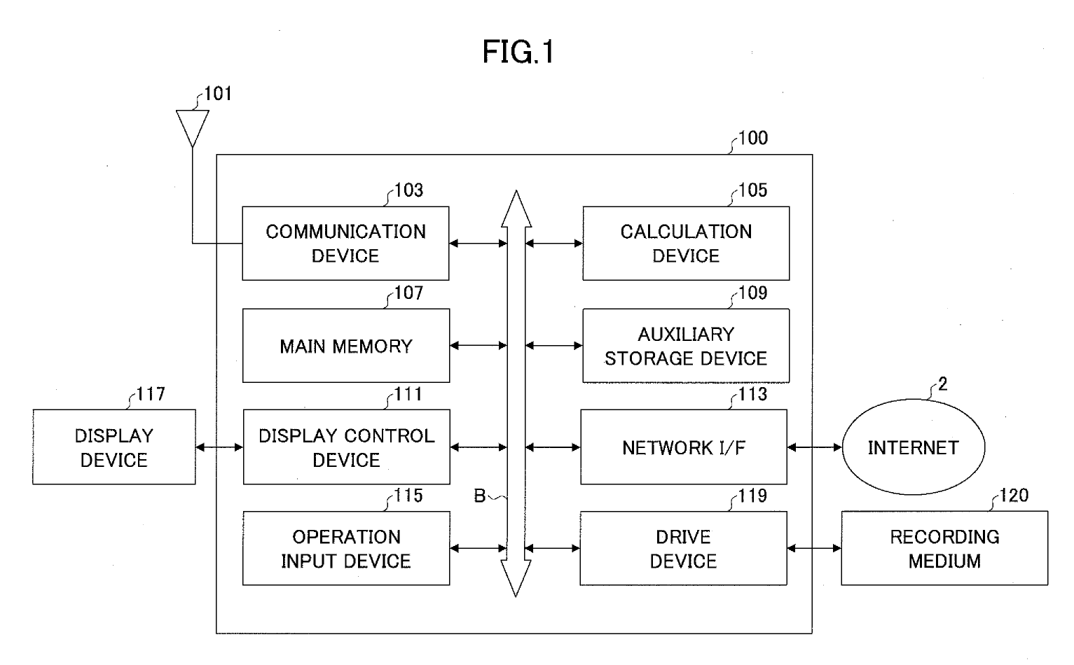

FIG. 1 is a block diagram illustrating an example of a hardware configuration of a video processing apparatus 100 in the embodiment. The video processing apparatus 100 includes a communication device 103, a calculation device 105, a main memory 107, an auxiliary storage device 109, a display control device 111, a network interface (I/F) 113, and an operation input device 115, which are mutually connected via a bus B and are capable of sending and receiving data.

The communication device 103 acquires the video data received by an antenna 101. The communication device 103 outputs the acquired video data to the calculation device 105. The video data include an audio signal and a video signal. The communication device 103 may include a tuner. Also, the communication device 103 may be connected to a cable television network, instead of the antenna 101.

The calculation device 105 is regarded as a processor such as a Central Processing Unit (CPU) which controls each of devices 103, 105, 107, 109, 111, 113, and 115, calculates and processes data in a computer. Also, the calculation device 105 may be regarded as a calculation device which executes a program stored in the main memory 107, and outputs data to an output device or a storage device after receiving, calculating, and processing the data received from an input device or the storage device.

The main memory 107 includes a Random Access Memory (RAM) or the like, and is regarded as the storage device which stores or temporarily stores programs and data pertinent to an Operating System (OS) being a basic software, application software, and the like, which are executed by the calculation device 105.

Also, the main memory 107 retains a decode program for decoding the video data, and the calculation device 105 executes the decode program and decodes the video data. The video processing apparatus 100 may include a decoding device as hardware, and the calculation device 105 may cause the decoding device decode the video data. The main memory 107 may function as a working memory used for processing by the video processing apparatus 100.

The auxiliary storage device 109 includes a Hard Disk Drive (HDD), and may be regarded as the storage device to store data related to the video data. The auxiliary storage device 109 stores the aforementioned decode program and a program for processing the video data which will be described later. These programs are loaded from the auxiliary storage device 109 to the main memory 107, and executed by the calculation device 105.

The display control device 111 controls a process for outputting the video data, selection screen data, or the like to a display device 117. The display device 117 may be a Cathode Ray Tube (CRT), a Liquid Crystal Display, and the like, and conducts a display respective to display data input from the display control device 111. In the example of the hardware configuration in FIG. 1, the display device 117 is externally connected to the video processing apparatus 100. The display device 117 may be included in the video processing apparatus in a case in which the video processing apparatus 100 is a receiver of a television, an information processing apparatus or the like.

The network I/F 113 interfaces between the video processing apparatus 100 and a device including a communication function, which are connected through the Internet 2 formed by networks such as a Local Area Network (LAN), a Wide Area Network (WAN), and the like which are formed by data transmission channels such as wired communications and/or wireless communications.

The process of the video data, which will be described in each of embodiments, may be realized by a program to be executed by the computer. This program may be installed from a server or the like and executed by the computer. Then, the process of the video data can be realized.

Also, this program may be stored in a recording medium 120. The recording medium 120 storing this program may be read out by the computer through a drive device 119. Then, the processing of the video data may be realized. The recording medium 120 may be formed by a non-transitory (or tangible) computer-readable recording medium. As the recording medium 120, various types of recording media may be used. A recording medium, which optically, electrically, or magnetically records information, such as a Compact Disk Read Only Memory (CD-ROM), a flexible disk, a magnetic optical disk, or the like may be used. A recording medium such as a semiconductor memory or the like, which electrically stores information, may also be used. The processing of the video data, which will be described in each of embodiments, may be implemented in one or multiple integrated circuits.

### <Functions>

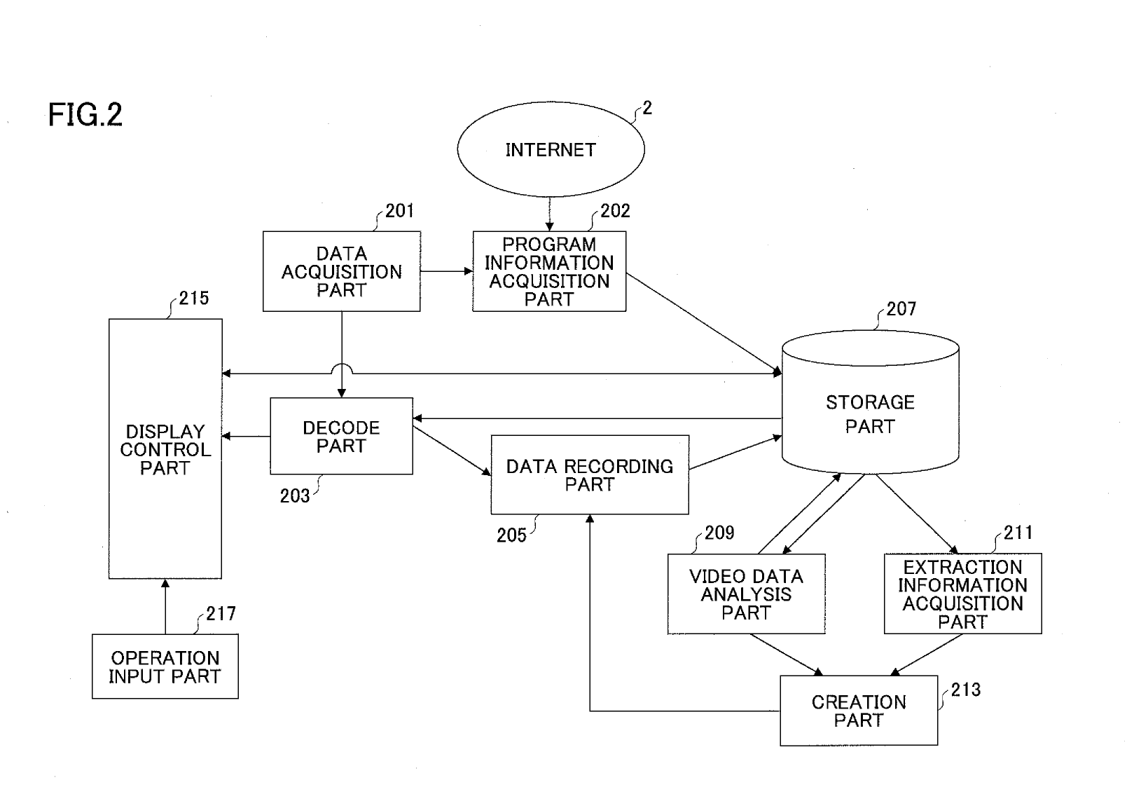

FIG. 2 is a block diagram illustrating an example of a functional configuration of the video processing apparatus 100 in the first embodiment. As illustrated in FIG. 2, the video processing apparatus 100 includes a data acquisition part 201, a program information acquisition part 202, a decode part 203, a data recording part 205, a storage part 207, a video data analysis part 209, an extraction information acquisition part 211, a creation part 213, a display control part 215, and an operation input part 217.

The program information acquisition part 202 may be realized by the network I/F 113, the calculation device 105, and the like. The decode part 203, the data recording part 205, the video data analysis part 209, the extraction information acquisition part 211, the creation part 213, and the display control part 215 may be realized by the calculation device 105, the main memory 107, and the like. The storage part 207 may be realized by the main memory 107, the auxiliary storage device 109, and the like. The operation input part 217 may be realized by the operation input device 115. The data acquisition part 201 may be realized by the communication device 103 when acquiring the video data from the airwaves. Also, the data acquisition part 201 may be realized by the network I/F 113 when acquiring the video data through the Internet 2.

The data acquisition part 201 may acquire the video data received by the antenna 101. Also, the data acquisition part 201 reads out and acquires the video data from the recording medium 120 where the video data are stored.

The program information acquisition part 202 acquires program information corresponding to the video data acquired by the data acquisition part 201 from the Internet 2 or the airwaves. The program information may be acquired from an Electronic Program Guide (EPG). The program information acquisition part 202 records the acquired program information to the storage part 207 by associating the video data corresponding to the program information. The program information includes a program title, program detail information, category information, and the like. When the category information is included in a header of the video data, the program information acquisition part 202 may not acquire the program information.

The decode part 203 acquires the video data acquired by the data acquisition part 201, and decodes the video data in accordance with a standard technology of a video compression such as a Motion Picture Experts Group (MPEG) 2, H.264, or the like. The decode part 203 outputs the decoded video data to the data recording part 205 when the video data are recorded. The decode part 203 outputs the decoded video data to the display control part 215 when the decoded video data are displayed in real time.

The data recording part 205 records the video data acquired from the decode part 203 to the storage part 207. The data recording part 205 records thumbnail data to the storage part 207 by associating the video data corresponding to the thumbnail data when the data recording part 205 acquires thumbnail from the creation part 213.

The storage part 207 records video information pertaining to the video data. The video information includes identification information of the video data, a title of the video data, a broadcast time, a category, details of the video data, and the like.

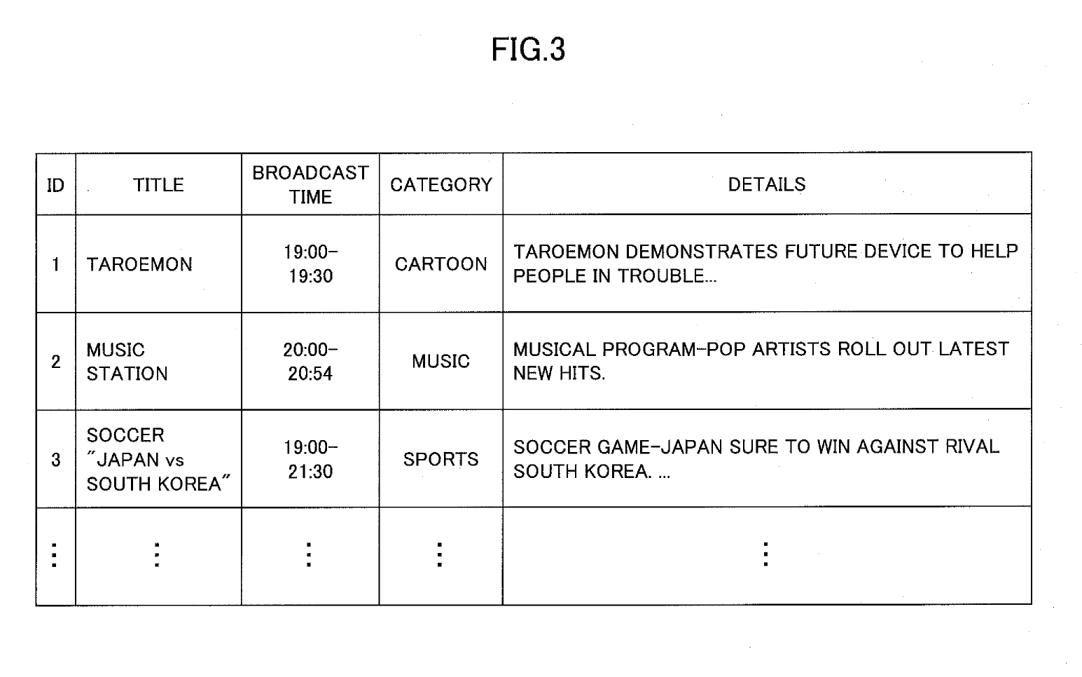

FIG. 3 is a diagram illustrating an example of the video information. In the example illustrated in FIG. 3, the video information is retained in the order of recording the video data, and “TAROEMON”, “MUSIC STATION”, and “SOCCER ‘JAPAN VS SOUTH KOREA’” are sequentially recorded.

The video information illustrated in FIG. 3 retains information included in the program information acquired by the program information acquisition part 202. Information of the title, the broadcast time, the category, the details, and the like are included in the video information. At least, the video information includes the category information. The category information indicates a type of the video data. In the example illustrated in FIG. 3, the category information of the “TAROEMON” is “CARTOON”, the category information of the “MUSIC STATION” is “MUSIC”, and the category information of the “SOCCER ‘JAPAN VS SOUTH KOREA’” is “SPORTS”.

Referring back to FIG. 2, the storage part 207 stores extraction information used to extract the thumbnail data of the video data for each of categories of the video data. The extraction information may indicate a location of a portion of the video data. In the extraction information, a configuration of general contents of the video data may be considered.

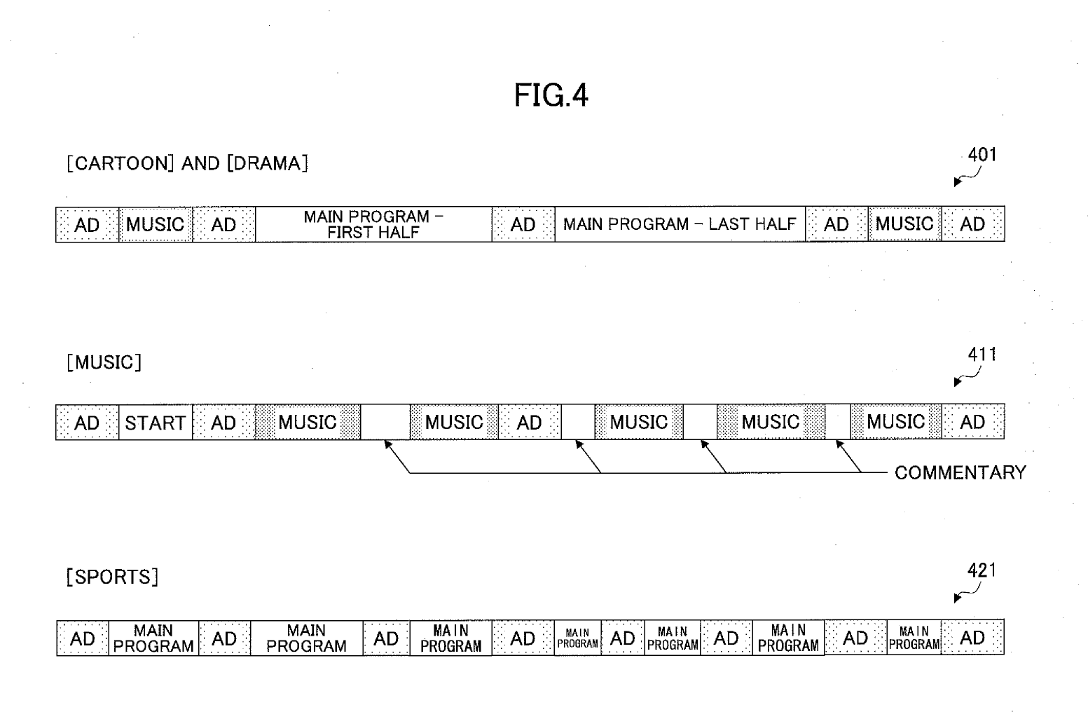

FIG. 4 is a diagram illustrating an example of configuration information of the general contents of the video data. In the example illustrated in FIG. 4, a configuration of the general contents is illustrated in which the categories are “CARTOON”, “DRAMA”, “MUSIC”, and “SPORTS”.

Configuration information 401 illustrated in FIG. 4 indicates a general configuration for the “CARTOON” and “DRAMA”. A program of the “CARTOON” or “DRAMA” may be formed by “AD”, “MUSIC” of an opening, “AD”, “MAIN PROGRAM—FIRST HALF”, “AD”, “MAIN PROGRAM—LAST HALF”, “AD”, “MUSIC” of an ending, and “AD”.

Configuration information 411 illustrated in FIG. 4 indicates a general configuration of a music program. The “MUSIC” program may be formed by “AD”, “START”, “AD”, “MUSIC” (first music), “COMMENTARY”, “MUSIC” (second music), “AD”, and the like.

Configuration information 421 illustrated in FIG. 4 indicates a general configuration of a sports program. The “SPORTS” program may be formed by “AD”, “MAIN PROGRAM” (prefight comments), “AD”, “MAIN PROGRAM”, “AD”, and the like.

As described above, the configuration of the contents is different depending on the category of the video data. In the video data in the same category, even if there is a different configuration, most configurations are similar to each other. Hence, one content configuration may be defined with respect to one category. Alternatively, one category may be segmented into detailed categories, and multiple content configurations may be defined. The category “SPORTS” may be segmented into categories “BASEBALL” and “SOCCER”, and the content configuration may be defined for each of segmented categories.

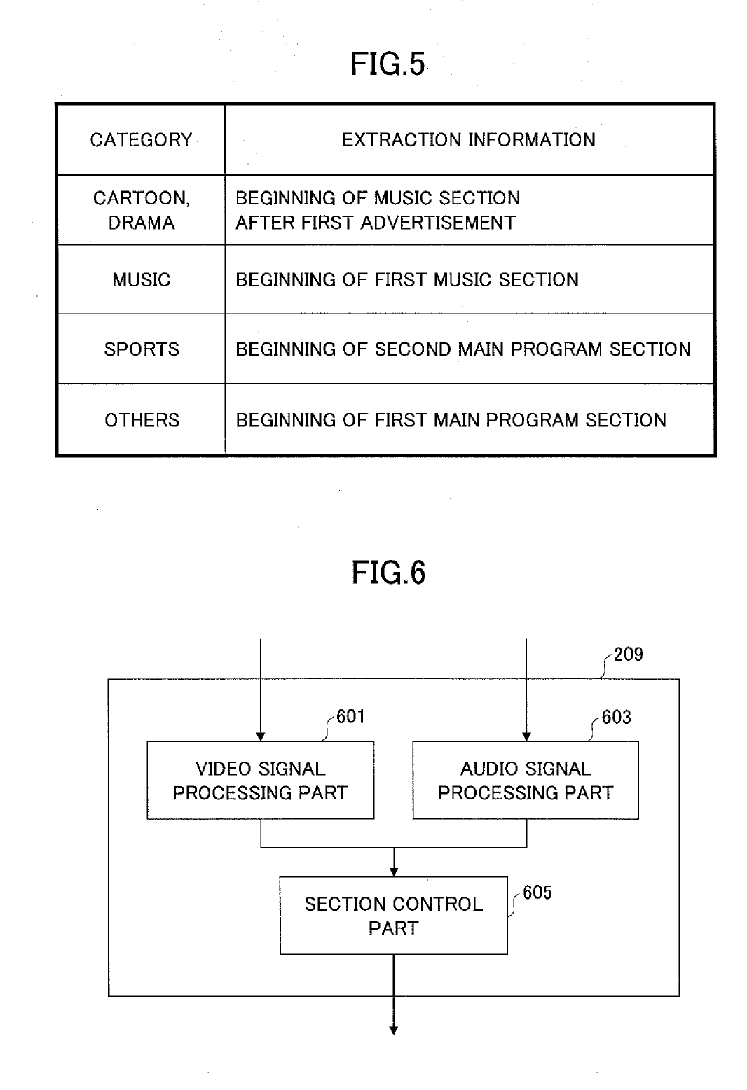

FIG. 5 is a diagram illustrating an example of the extraction information. The extraction information illustrated in FIG. 5 indicates a location in the video data to extract as the thumbnail for each category. In the example illustrated in FIG. 5, for the video data of the category “CARTOON” or “DRAMA”, a beginning of a music section after a first AD is extracted as the thumbnail data. For the video data of the category “MUSIC”, a beginning of a first music section is extract as the thumbnail data. For the video data of the category “SPORTS”, a beginning of a second main program section is extracted as the thumbnail data.

For the video data of a category “OTHERS”, a beginning of a first main section is extracted as the thumbnail data. In a case in which the video data does not correspond to categories “CARTOON”, “DRAMA”, “MUSIC”, and “SPORTS”, the video data are categorized into the category “OTHERS”. Hence, the extraction information may consider the content configuration of the video data for each category. In a different manner from the example illustrated in FIG. 5, the extraction information may be defined by using time so as to extract data as the thumbnail data at a predetermined time passed from the start of the video data.

Referring back to FIG. 2, the video data analysis part 209 acquires the video data stored in the storage part 207, and conducts an analysis of the video data. In the analysis of the video data, an advertisement (AD) section is detected, the music section is detected, and the video data are divided into predetermined sections. The analysis of the video data will be described below in detail.

FIG. 6 is a block diagram illustrating an example of a function of the video data analysis part 209. As illustrated in FIG. 6, the video data analysis part 209 includes a video signal processing part 601, an audio signal processing part 603, and a section control part 605. In the example illustrated in FIG. 6, the video data are input to the video data analysis part 209 in a state in which the video signal and the audio signal are separated. The video data analysis part 209 may be formed to separate the video signal and the audio signal from the input video data.

The video signal processing part 601 acquires the video signal from the storage part 207, and detects a scene change. The video signal processing part 601 may detect a scene in which a difference value of a pixel between images being successive in a time sequence is greater than a predetermined value.

Moreover, the video signal processing part 601 may detect, by using a motion vector, a scene including a larger number of blocks having a greater motion vector. Also, Japanese Laid-open Patent Publication No. 2000-324499 discloses a first image correlation operation part, and a second image correlation operation part. The first image correlation operation part calculates a first image correlation value between frames of an input image signal. The second image correlation operation part calculates a second image correlation value between frames related to the first image correlation value. Also, Japanese Laid-open Patent Publication No. 2000-324499 discloses to detect the scene change by comparing the second image correlation value with a first threshold. That is, the video signal processing part 601 may detect the scene change by using the video signal by the above-described well-known technology. The video signal processing part 601 outputs time information (which may indicate how much time from the start of the video data) of the detected scene change.

The audio signal processing part 603 acquires the audio signal from the storage part 207, and detects the scene change based on the audio signal. The audio signal processing part 603 may set a minimum level of the audio signal in a certain section to be a background audio level, and may determine a time point where the background audio level is greatly changed, as a scene change.

Also, the audio signal processing part 603 may detect a silent section, and determine the silent section as the scene change. Japanese Laid-open Patent Publication No. 2003-29772 discloses to extract a spectrum amplitude of each spectrum signal by decomposing spectrum of an input audio signal, to acquire a spectrum change amount which is normalized by a spectrum energy based on a smoothed spectrum signal, and to detect the scene change. As described above, the audio signal processing part 603 detects the scene change by using the well-known technology, and outputs the detected time point to the section control part 605.

Moreover, the audio signal processing part 603 extracts the silent section and a sound section from the audio signal, and further determines whether the sound section is a voice section or a music section. Japanese Laid-open Patent Publication No. 10-247093 discloses a technology for determining the music section. According to this document (Japanese Laid-open Patent Publication No. 10-247093), the audio signal processing part 603 calculates an average energy AE per unit time from an energy Ei of each of frames, and determines the sound section if the average energy AE is greater than a first threshold (α1).

$$Ei = {\sum }_{n = 1}^{32} {( Si ( n ) )}^{2} \qquad ( 1 )$$

Si indicates sub-band data, and n indicates a sub-band number.

$$AE = {\sum }_{i = 1}^{j} Ei \qquad ( 2 )$$

j indicates a frame number per second.

AE>α1 (3)

The audio signal processing part 603 calculates an energy change rate CE per energy unit time. The energy change rate CE is regarded as a summation in the unit time of a ratio between two energies of adjacent frames in which the energies are acquired from the sub-band data of a MPEG coding data. The audio signal processing part 603 determines the voice section if the energy change rate CE is greater than a second threshold (α2).

AE>α2 (4)

In a case of voice, a time waveform of the voice is changed every work and syllabic sound, and many silent sections are included. Hence, the energy change rate CE becomes greater than the music section.

In order to determine the music section in the sound section, the audio signal processing part 603 calculates an average band energy Bmi, and determines the music section if the average band energy Bmi is less than a third threshold (α3).

$$\begin{matrix}Bmi = \frac{{\sum }_{n = 0}^{k - 1} {( Si ( n ) )}^{2}}{{\sum }_{n = k}^{31} {( Si ( n ) )}^{2}} & ( 5 ) \\ Bmi < α 3 & ( 6 )\end{matrix}$$

The audio signal processing part 603 outputs the detected music section to the section control part 605.

The section control part 605 stores the time point where the scene change is changed simultaneously by the video signal processing part 601 and the audio signal processing part 603. The section control part 605 determines whether an interval between a latest time point to be currently stored and a previous time point being already stored is a predetermined time T. The predetermined time T may indicate 15, 30, 60 seconds, or the like which is used as an advertisement interval.

The section control part 605 determines that the previous time point indicates a start time if the interval between the latest time point to be currently stored and the previous time point being already stored is the predetermined time T. To detect the AD section, the section control part 605 may use the above-described well-known technology for detecting sections other than the AD section.

The section control part 605 determines the music section acquired from the audio signal processing part 603 for the sections other than the AD section, and defines sections other than the AD section and the music section as the main program section. A section detection by the video data analysis part 209 may be conducted by using a well-known technology other than the above-described methods.

Also, the video data analysis part 209 may determine contents of the section based on the content configuration being stored if the content configuration as illustrated in FIG. 4 is stored.

The video data analysis part 209 sequentially detects scene changes of the video data, and determines the contents in the section between the detected scene changes. The video data analysis part 209 determines a section between first scene changes to be “AD” based on the configuration information 401 in FIG. 4 when the category of the video data is “CARTOON” or “DRAMA”. The video data analysis part 209 determines a section between following scene changes to be “MUSIC” based on the configuration information 401. The video data analysis part 209 sequentially determines the contents of the section by repeating this process. According to this process, the video data analysis part 209 may simply detect the section, but does not analyze the contents of the section. Hence, it is possible to reduce a process workload by the video analysis.

Referring back to FIG. 2, the extraction information acquisition part 211 acquires the extraction information corresponding to the category of the video data analyzed by the video data analysis part 209, from the storage part 207. The extraction information acquisition part 211 outputs the acquired extraction information to the creation part 213.

The creation part 213 extracts a portion of the video data from the analyzed video data based on the extraction information acquired from the part extraction information acquisition part 211, and creates the thumbnail data based on the extracted portion of the video data. When the extraction information indicates the beginning of the first music section, the beginning of the first music section is extracted from the analyzed video data, and creates the thumbnail data. The creation part 213 outputs the created thumbnail data to the data recording part 205. If the extraction information is time information indicating how much time passed from the start of the video data, the creation part 213 may create the portion of the video data from previous video data to be analyzed. By this process, since the video analysis is not conducted, it is possible to reduce the process workload.

The creation part 213 may create the thumbnail data by processing the portion of the extracted video data. The creation part 213 may additionally provide character data of the title and the like to the portion of the extracted video data, and create the thumbnail data by enlarging or reducing the portion.

In the first embodiment, the thumbnail data indicates the portion itself of the video data. Also, the thumbnail data may be regarded as management information including the portion of the video data, a start time of the portion of the video data, a start time and an end time of the video data, or the like.

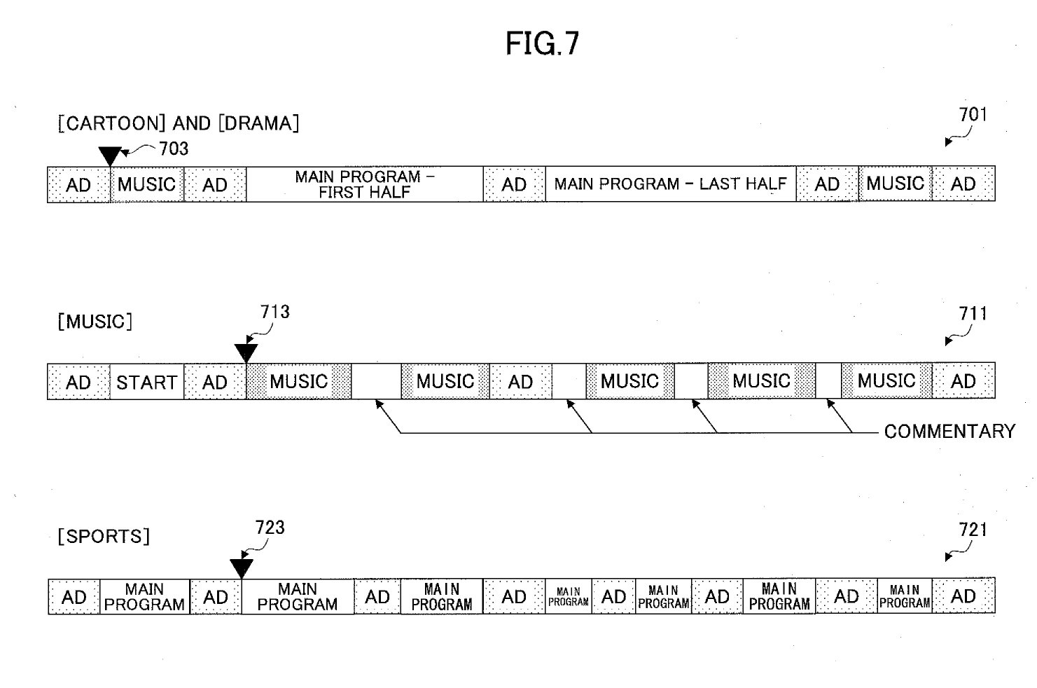

FIG. 7 is a diagram illustrating an example of a scene extracted as the thumbnail. In the example illustrated in FIG. 7, the creation part 213 extracts the thumbnail data based on the extraction information illustrated in FIG. 5

The category of analyzed video data 701 illustrated in FIG. 7 is “CARTOON” or “DRAMA”. The creation part 213 acquires the analyzed video data 701 from the video data analysis part 209. The creation part 213 extracts the “beginning of the music section after the first AD” indicated by the extraction information for the category “CARTOON” or “DRAMA” as the thumbnail data from the analyzed video data 701 being acquired. A mark 703 indicates the portion of the video data extracted as suitable thumbnail data with respect to the video data of the “CARTOON” or “DRAMA”.

The category of analyzed video data 711 illustrated in FIG. 7 is the “MUSIC”. The creation part 213 acquires the analyzed video data 711 from the video data analysis part 209. The creation part 213 extracts the “beginning of the first music section” indicated by the extraction information for the category “MUSIC” as the thumbnail data. A mark 713 indicates the portion of the video data extracted as the suitable thumbnail data with respect to the video data of the “MUSIC”.

The category of analyzed video data 721 illustrated in FIG. 7 is “SPORTS”. The creation part 213 acquires the analyzed video data 721 from the video data analysis part 209. The creation part 213 extracts the “beginning of the second main program section” indicated by the extraction information of the category “SPORTS” as the suitable thumbnail data from the analyzed video data 721 being acquired. A mark 723 indicates the portion of the video data extracted as the suitable thumbnail data with respect to the video data of the “SPORTS”.

Referring back to FIG. 2, the data recording part 205 records the thumbnail acquired from the creation part 213 by associating original video data before an extraction. The data recording part 205 may record the thumbnail data acquired from the creation part 213 by associating the analyzed video data before the extraction.

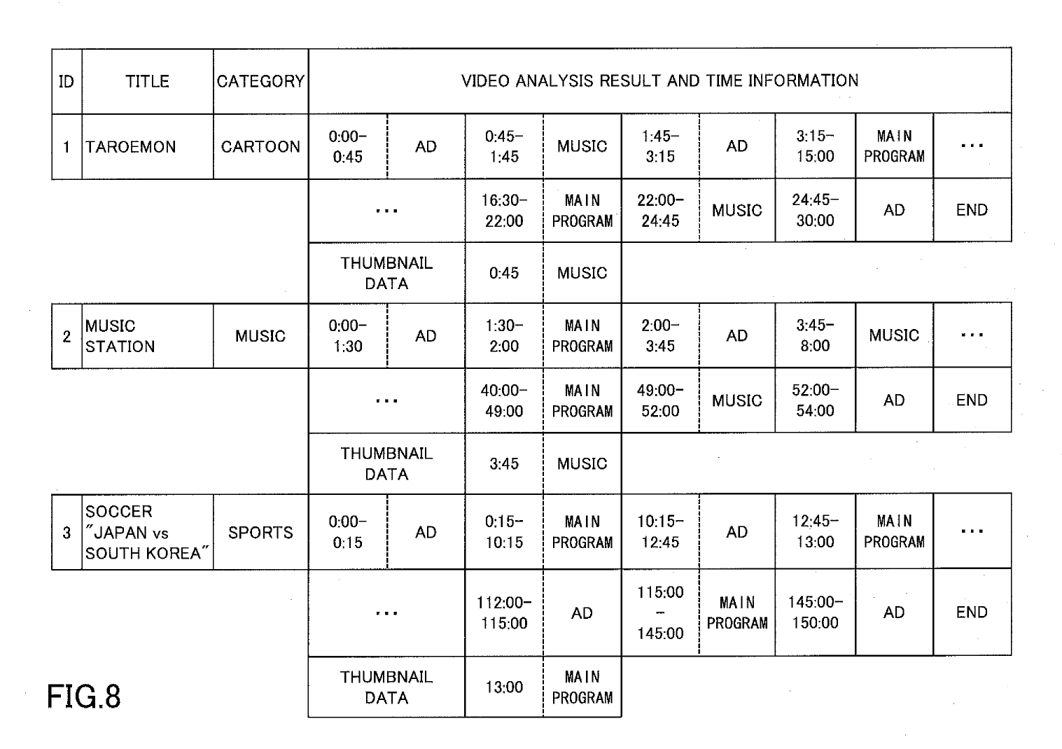

FIG. 8 is a diagram illustrating an example of analysis result information of the video data stored in the storage part 207. The analysis result information illustrated in FIG. 8 retains an ID of the video data, the title, the category, and a video analysis result by associating the time information.

The title of the video data of the ID “1” illustrated in FIG. 8 is “TAROEMON”, and the category thereof is “CARTOON”. As the video analysis result, the analyzed video data 701 illustrated in FIG. 7 are acquired. The time information is illustrated in FIG. 8 in a case in which the start time is 0:00. The “THUMBNAIL DATA” places at the beginning of the music section after the first AD. A scene at 45 seconds after the start of the video data is used as the thumbnail data.

The title of the video data of the ID “2” illustrated in FIG. 8 is “MUSIC STATION”, and the category thereof is the “MUSIC”. As the video analysis result, the analyzed video data 711 illustrated in FIG. 7 are acquired. The “THUMBNAIL DATA” places at the beginning of the first music section. A scene at 3 minutes and 45 seconds after the start of the video data is used as the thumbnail data.

The title of the video data of the ID “3” illustrated in FIG. 8 is “SOCCER “JAPAN VS SOUTH KOREA””, and the category thereof is “SPORTS”. As the video analysis result, the analyzed video data 721 illustrated in FIG. 7 is acquired. The “THUMBNAIL DATA” places at the beginning of the first music section. A scene at 3 minutes and 45 seconds after the start of the video data is used as the thumbnail data.

Referring back to FIG. 2, when receiving a display request of the thumbnail from the operation input part 217, the display control part 215 acquires the thumbnail data and information included in the video information from the storage part 207, and displays the thumbnail data and the information at the display control device 111. The operation input part 217 may include function buttons of a main body of the video processing apparatus 100, and outputs a signal of a display request to the display control part 215.

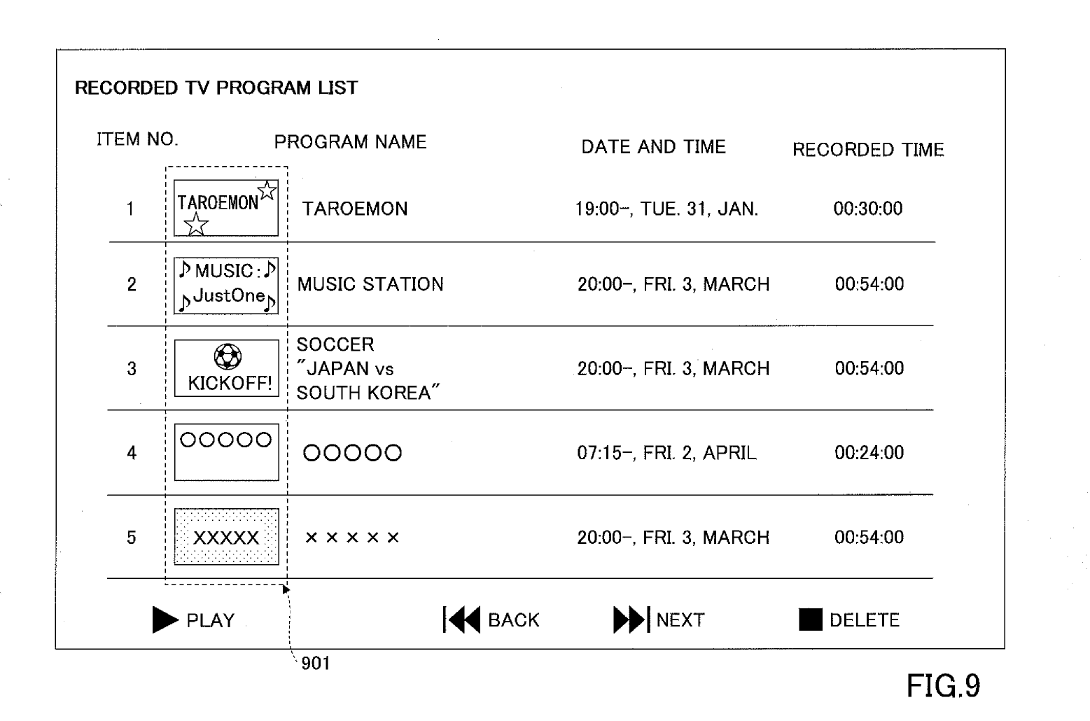

FIG. 9 is a diagram illustrating an example of a screen which displays a recorded television (TV) program list. In FIG. 9, a case of recording a TV program is recorded as the video data. In the recorded TV program list illustrated in FIG. 9, an item number (which may indicate an ID) of the TV program, the thumbnail data, a program name, a date and time, recorded time, and the like are displayed.

The display control part 215 acquires the thumbnail data, the program title, and the like from information illustrated in FIG. 8, and sends display screen data to the display apparatus 117. The display control part 215 acquires one scene of the beginning of the music section at 45 seconds passed from the start of the video data as the thumbnail data of the program name “TAROEMON”, reduces an image of the scene, and controls the display device 117 to display the reduced image. In a case in which the thumbnail data have been already acquired as the reduced image, the display control part 215 controls the display device 117 to display the reduced image without a reduction process. In a cartoon, the beginning of the music section mostly includes the program name. Thus, the beginning of the music section is more preferable for the thumbnail data than a scene of the main program.

The image data included in an area 901 illustrated in FIG. 9 is regarded as the thumbnail data for each program. Each set of the thumbnail data is displayed at the display device 117 by the display control part 215 which acquires the thumbnail data stored in the storage part 207.

### <Operations>

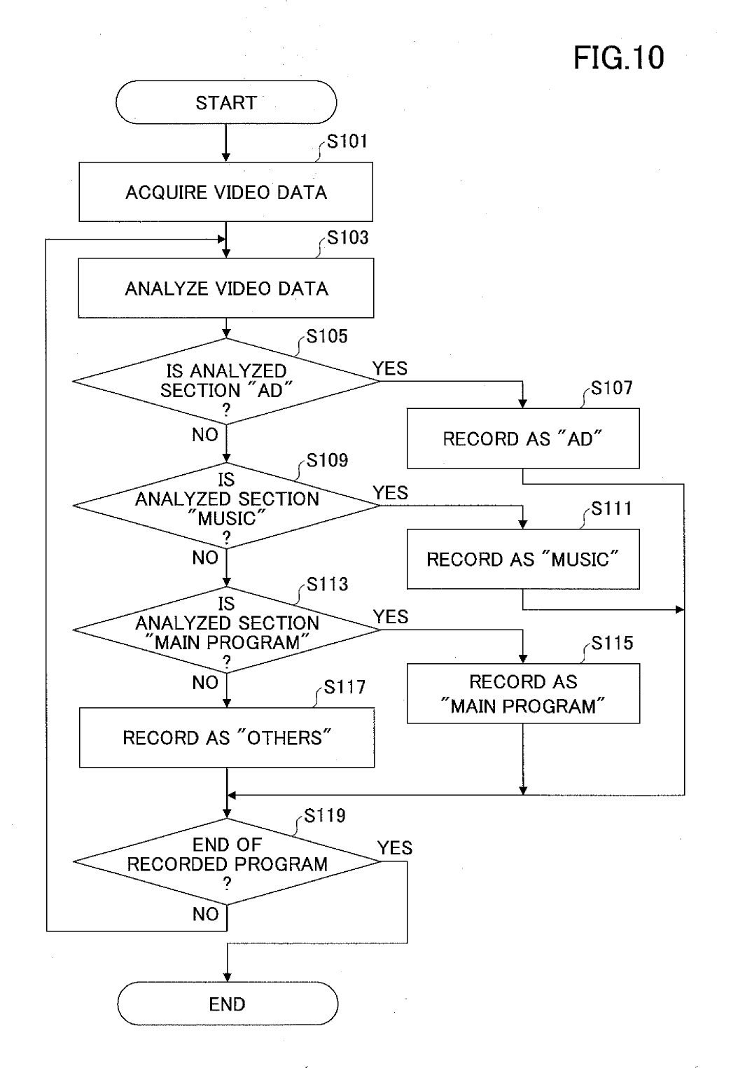

Next, an operation of the video processing apparatus 100 in the first embodiment will be described. FIG. 10 is a flowchart for explaining an example of an analysis process conducted by the video data analysis part 209. In step S101 illustrated in FIG. 10, the video data analysis part 209 acquires the video data from the storage part 207.

In step S103, the video data analysis part 209 analyzes the video data acquired from the storage part 207. The analysis process divides the video data into sections. The above-described section control may be performed.

In step S105, the video data analysis part 209 determines whether a detected section by the analysis is the AD section. When a determination result of step S105 indicates YES (the detected section is the AD section), the video data analysis part 209 advances to step S107. When the determination result indicates NO (the detected section is not the AD section), the video data analysis part 209 advances to step S109.

In step S107, the video data analysis part 209 records the detected section as the AD section in the storage part 207.

In step S109, the video data analysis part 209 determines whether the detected section by the analysis is the music section. If a determination result of step S109 indicates YES (the detected section is the music section), the video data analysis part 209 advances to step S111. If the determination result indicates NO (the detected section is no the music section), the video data analysis part 209 advances to step S113.

In step S111, the video data analysis part 209 records the detected section as the music section in the storage part 207.

In step S113, the video data analysis part 209 determines whether the detected section by the analysis is the main program section. The main program section may be the voice section. If a determination result of step S113 indicates YES (the detected section is the main program section), the video data analysis part 209 advances to step S115. If the determination result indicates NO (the detected section is not the main program section), the video data analysis part 209 advances to step S117.

In step S115, the video data analysis part 209 records the detected section as the main program section in the storage part 207.

In step S117, the video data analysis part 209 records an analyzed section as the “OTHERS” in the storage part 207.

In step S119, the video data analysis part 209 determines whether the recorded program ends. If a determination result of the step S119 indicates YES (the video data end), the analysis process is terminated. If the determination result indicates NO (the video data have not ended), the video data analysis part 209 goes back to step S103 to analyze a next section. The end of the recorded program is determined when information indicating an end of the video data, or by determining whether the video data itself has run out.

Steps S105 and S107, steps S109 and S111, and steps S113 and S115 may be performed in a different order. These processes may be performed at the same time.

By the above-described processes, the video data analysis part 209 analyzes the video data stored in the storage part 207, records the analyzed video data to the storage part 207, and outputs the analyzed video data to the creation part 213.

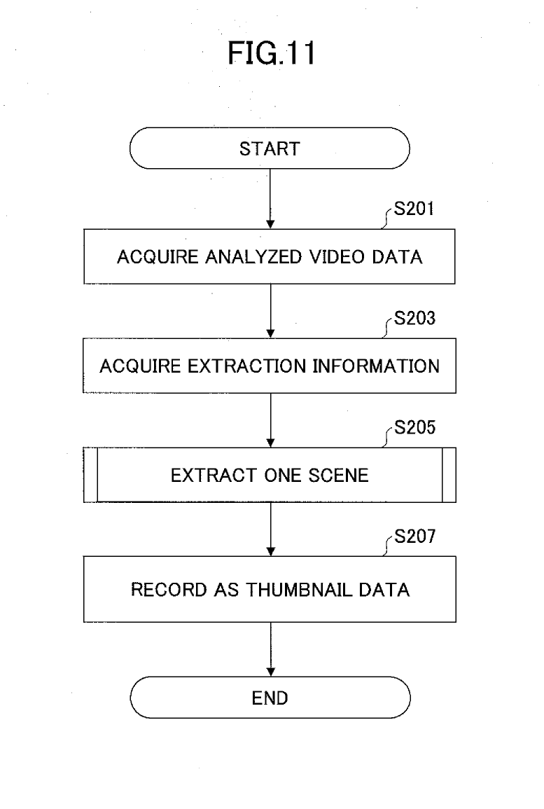

FIG. 11 is a flowchart for explaining an example of a creation process of the thumbnail data. In step S201 illustrated in FIG. 11, the creation part 213 acquires the analyzed video data from the video data analysis part 209.

In step S203, the extraction information acquisition part 211 acquires the extraction information from the storage part 207. The extraction information acquisition part 211 outputs the acquired extraction information to the creation part 213.

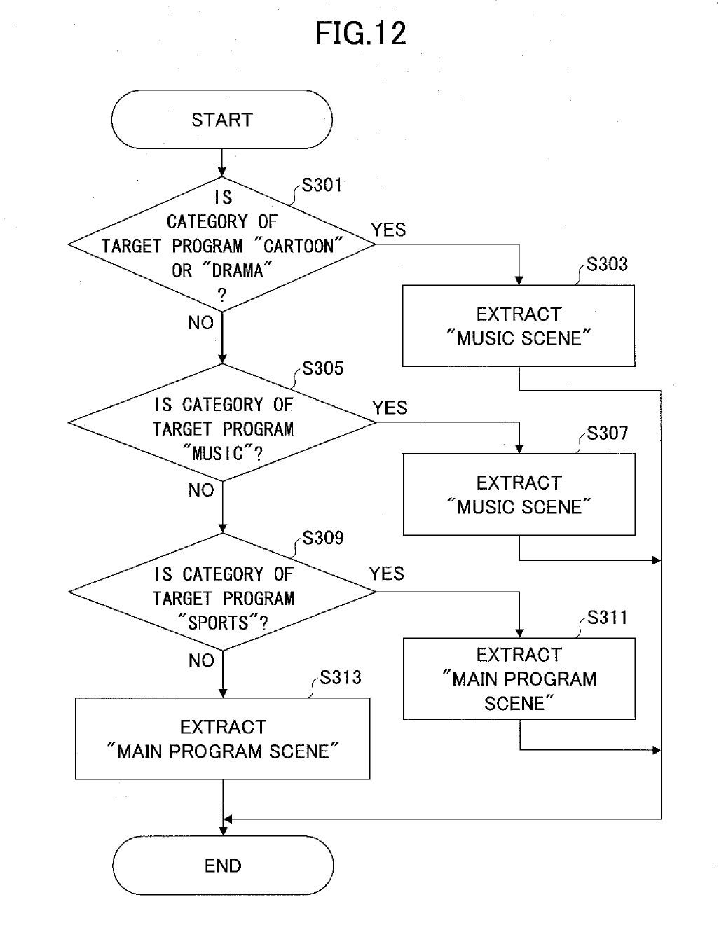

In step S205, the creation part 213 extracts the portion of the video data, and creates the thumbnail data based on the extraction information corresponding to the category of the analyzed video data. The extraction information acquisition part 211 may output only the extraction information corresponding to the category of the analyzed video data. In this case, the extraction information acquisition part 211 acquires the category of the video data being analyzed, from the video data analysis part 209. The extraction process of the thumbnail data will be described with reference to FIG. 12.

The creation part 213 may directly acquire the analyzed video data from the video data analysis part 209. Alternatively, the creation part 213 may directly acquire the analyzed video data stored in the storage part 207.

In step S207, the creation part 213 instructs the storage part 207 to record the created thumbnail data. When the data recording part 205 receives an instruction from the creation part 213, the data recording part 205 records information of the thumbnail data indicated to record, to the storage part 207 by associating the analyzed video data.

The creation part 213 may directly record the information of the thumbnail data to the storage part 207. The information of the thumbnail data may include a start time of the thumbnail data, a location of the thumbnail data in time sequence of the video data, an image or a video clip which is the portion of the extracted video data. In the example illustrated in FIG. 8, the start time of the thumbnail data is indicated as the information of the thumbnail data.

Next, the extraction process of the thumbnail data will be described. FIG. 12 is a flowchart for explaining an example of the extraction process of the thumbnail data. In step S301 illustrated in FIG. 12, the creation part 213 determines whether the category of the analyzed video data is the “CARTOON” or “DRAMA”. If a determination result of step S301 indicates YES (the category is the “CARTOON” or “DRAMA”), the creation part 213 advances to step S303. If the determination result indicates NO (the category is not the “CARTOON” or “DRAMA”), the creation part 213 advances to step S305.

In step S303, the creation part 213 extracts a music scene of the music section after the first advertisement from the analyzed video data based on the extraction information (refer to FIG. 5) of the “CARTOON” or “DRAMA”.

In step S305, the creation part 213 determines whether the category of the analyzed video data is the “MUSIC”. If a determination result of step S305 indicates YES (the analyzed video data are the music program), the creation part 213 advances to step S307. If the determination result indicates NO (the analyzed video data are not the music program), the creation part 213 advances to step S309.

In step S307, the creation part 213 extracts the music scene of the first music section from the analyzed video data based on the extraction information (refer to FIG. 5) of the music.

In step S309, the creation part 213 determines whether the category of the analyzed video data is the “SPORTS”. If a determination result of step S309 indicates YES (the analyzed video data are the sports program), the creation part 213 advances to step S311. If the determination result indicates NO (the analyzed video data are the sports program), the creation part 213 advances to step S313.

In step S311, the creation part 213 extracts a scene of the second main program section from the analyzed video data based on the extraction information (refer to FIG. 5) of the sports.

In step S313, the creation part 213 extracts a scene of the first main program section from the analyzed video data based on the extraction information (refer to FIG. 5) of the others.

Steps S301 and S303, steps S305 and S307, and steps S309 and S311 may be performed in a different order. These processes may be performed at the same time.

In the above-described processes, the video analysis and a thumbnail data creation are separately performed. In the first embodiment, the thumbnail data may be created while performing the video analysis. When the portion of the video data indicated by the extraction information is extracted by the creation part 213, the video analysis of the video data analysis part 209 is terminated.

By these processes, the creation part 213 creates the thumbnail data based on the category of the video data from which the thumbnail data are extracted.

According to the first embodiment, by considering the content configuration of the video data, it is possible to extract the scene suitable for the user as the thumbnail data. The thumbnail data are a portion of the video data. The thumbnail data are not limited to one scene. The thumbnail data may be a movie of a predetermined time length.

### SECOND EMBODIMENT

Next, a video processing apparatus in a second embodiment will be described. In the second embodiment, the user is allowed to select the thumbnail data from multiple portions of the video data which are extracted in response to the category of the video data. A hardware configuration of the video processing apparatus in the second embodiment may be the same as that illustrated in FIG. 1.

### <Functions>

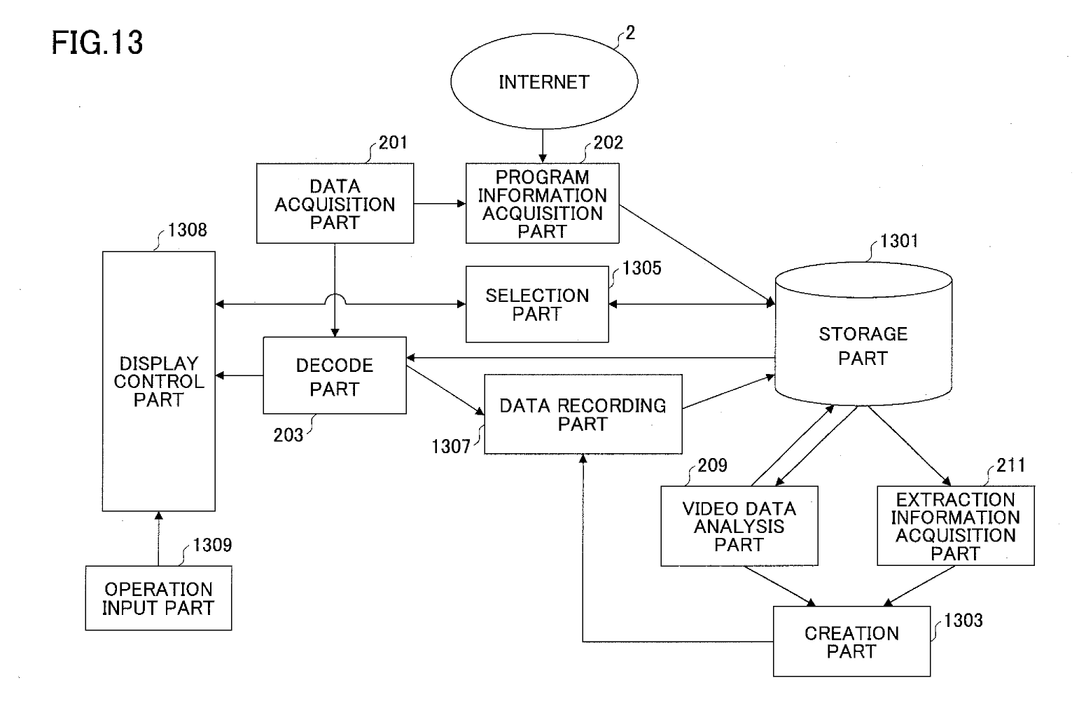

Next, functions of the video processing apparatus in the second embodiment will be described. FIG. 13 is a block diagram illustrating an example of a functional configuration of the video processing apparatus in the second embodiment. In FIG. 13, functions that are the same as those illustrated in FIG. 2 are designated by the same reference numerals, and the description thereof is omitted.

The video processing apparatus illustrated in FIG. 13 includes a storage part 1301, a creation part 1303, a selection part 1305, a data recording part 1307, a display control part 1308, and an operation input part 1309.

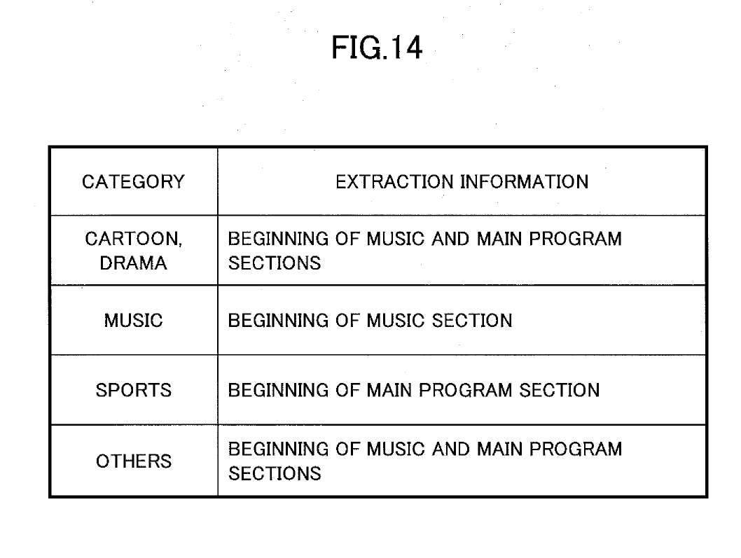

The storage part 1301 stores the extraction information in the second embodiment. FIG. 14 is a diagram illustrating an example of the extraction information in the second embodiment. Also, the storage part 1301 stores multiple candidates of the thumbnail data. The candidates are extracted by the creation part 1303.

The creation part 1303 creates the thumbnail data based on the extraction information stored in the storage part 1301. The creation part 1303 extracts multiple thumbnail candidates based on the extraction information corresponding to the category of the analyzed video data.

The thumbnail candidate may be the portion of the video data extracted based on the extraction information. In a case of the extraction information illustrated in FIG. 14, if the category of the video data is the “CARTOON” or “DRAMA”, the beginnings of the music and main program sections are extracted as the thumbnail candidates.

The creation part 1303 outputs the multiple extracted thumbnail candidates to the data recording part 1307. The creation part 1303 may directly record the multiple extracted thumbnail candidates to the storage part 1301. In the extraction information, for any category or all categories, the beginnings, midpoints, ends of the music and main program sections, or the like may be set.

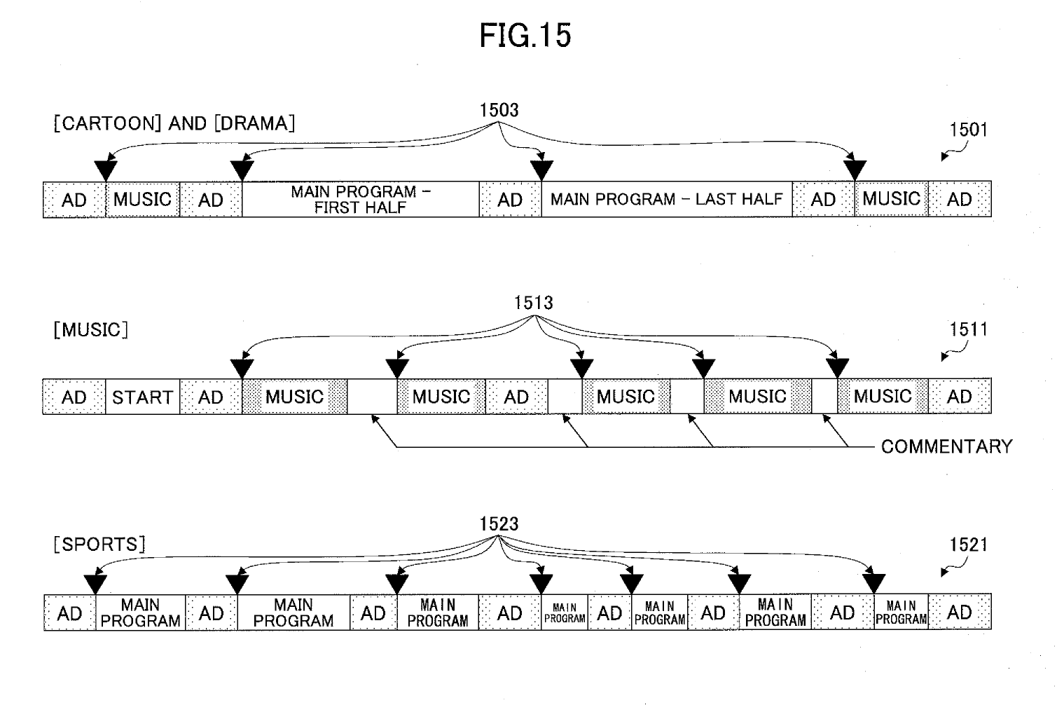

FIG. 15 is a diagram illustrating examples of the thumbnail candidates. In FIG. 15, the examples are illustrated in a case of extracting the thumbnails based on the extraction information illustrated in FIG. 14. If the category of analyzed video data 1501 is the “CARTOON” or “DRAMA”, the beginnings of the music and main program sections are selected as the thumbnail candidates. Marks 1503 indicate the thumbnail candidates, respectively. There may be multiple thumbnail candidates.

If the category of analyzed video data 1511 is the “MUSIC”, beginnings of the music sections are set as the thumbnail candidates, respectively. Marks 1513 indicate the thumbnail candidates, respectively.

If the category of analyzed video data 1521 is the “SPORTS”, beginnings of the main program sections are set as the thumbnail candidates, respectively. Marks 1523 indicate the thumbnail candidates, respectively.

Referring back to FIG. 13, the data recording part 1307 records the multiple thumbnail candidates acquired from the creation part 1303 to the storage part 1301 by associating the analyzed video data.

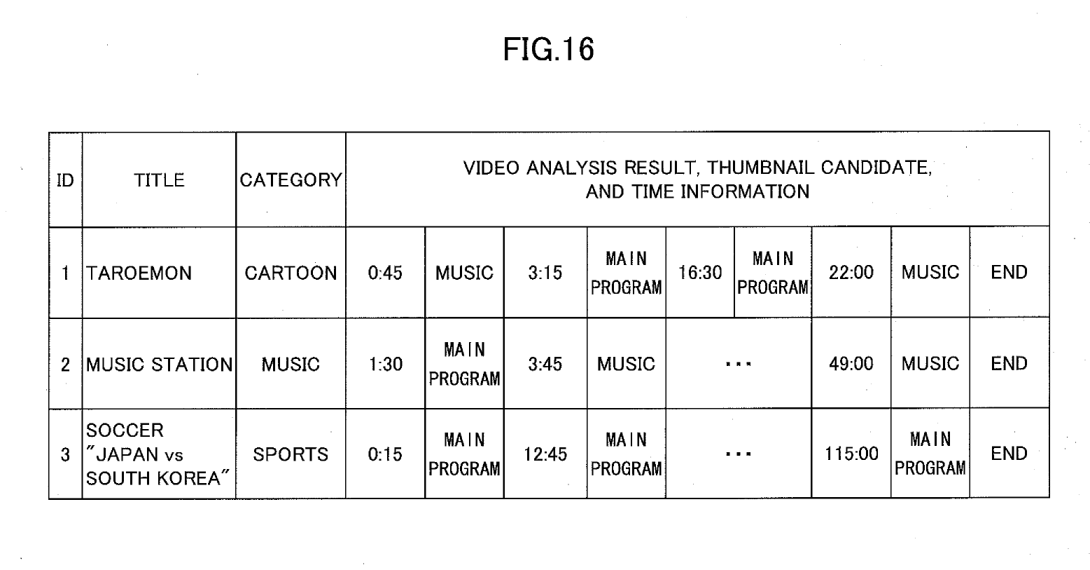

FIG. 16 is a diagram illustrating examples of the video analysis results and thumbnail candidates. In the examples illustrated in FIG. 16, for one program, there are the multiple thumbnail candidates. The time information is illustrated in FIG. 16 in a case in which the start time is 0:00. For the cartoon “TAROEMON”, scenes at 45 seconds, 3 minutes and 15 seconds, 16 minutes and 30 seconds, and 22 minutes passed from the start of the video data are selected as the thumbnail candidates.

For the music program “MUSIC STATION”, scenes at one minute and 30 seconds, 3 minutes and 45 seconds, . . . , 49 seconds passed from the start of the video data are selected as the thumbnail candidates. For the sports program “SOCCER “JAPAN VS SOUTH KOREA””, 15 seconds, 12 minutes and 45 seconds, . . . , 115 minutes after the start of the video data are selected as the thumbnail candidates. Information illustrated in FIG. 16 is stored in the storage part 1301.

When the display control part 1308 receives a display request of a selection screen of the thumbnail candidates for predetermined video data from the operation input part 1309, the display control part 1308 reports the display request to the selection part 1305. When the selection part 1305 receives the display request of the selection screen from the display control part 1308, the selection part 1305 acquires the thumbnail candidates for the predetermined video data from the storage part 1301, and outputs the thumbnail candidates to the display control part 1308. The display control part 1308 sends screen data of the selection screen for selecting one of the thumbnail candidates to the display device 117.

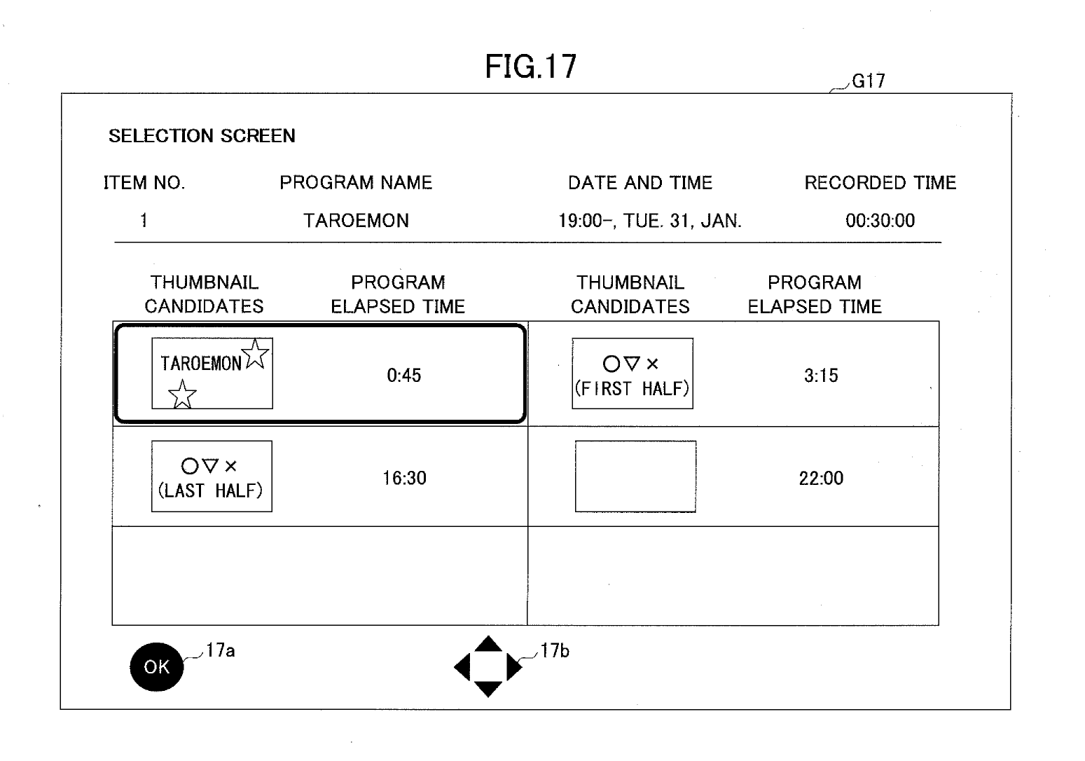

FIG. 17 is a diagram illustrating an example of the selection screen of the thumbnail candidates. In a selection screen G17 illustrated in FIG. 17, the thumbnail candidates are illustrated for the title “TAROEMON”. In the example illustrated in FIG. 17, the selection screen G17 of the thumbnail candidates is illustrated based on the thumbnail candidates of the “TAROEMON” in FIG. 16. As illustrated in FIG. 17, scenes at 45 seconds, 3 minutes and 15 seconds, 16 minutes and 30 second, and 22 minutes passed from the start of the video data are displayed in the selection screen G17. An OK button 17a and selection buttons 17b to up, down, right, and left may be used to select one of the thumbnail candidates.

When the display control part 1308 acquires an OK request for the thumbnail from the operation input part 1309, the display control part 1308 outputs the thumbnail candidate which is selected when the OK button 17a is selected, to the selection part 1305. The selection part 1305 outputs the selected thumbnail candidate to the storage part 1301. The selected thumbnail candidate is stored as defined thumbnail data in the storage part 1301 by associating the analyzed video data. After that, when the thumbnail is displayed, the defined thumbnail data are used.

### <Operations>

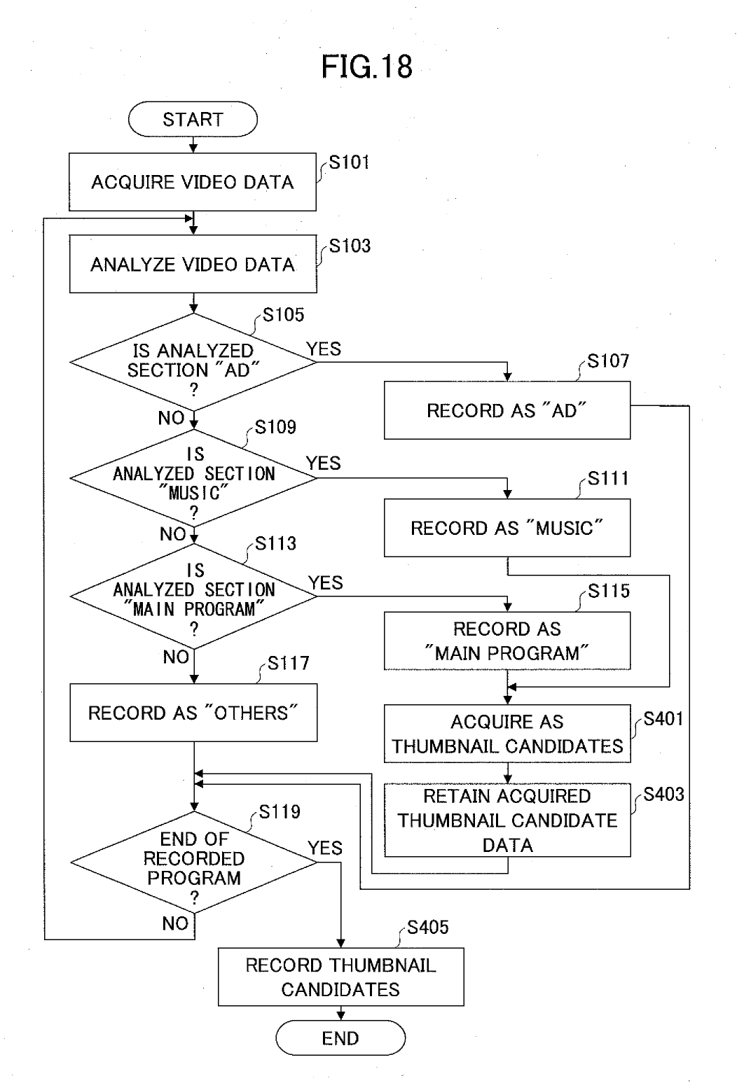

Next, operations of the video processing apparatus in the second embodiment will be described. FIG. 18 is a flowchart for explaining examples of a video analysis process and a thumbnail candidate extraction process in the second embodiment. In FIG. 18, processes that are the same as those illustrated in FIG. 10 are designated by the same reference numerals, and the explanations thereof are omitted. Processes in FIG. 18 are to conduct a video analysis and an extraction of the thumbnail candidates at the same time. The beginnings of the music and main program sections may be extracted as the thumbnail candidates.

In step S401, the creation part 1303 acquires scenes of the music sections or scenes of the main program sections as the thumbnail candidates. In step S403, the creation part 1303 retains the acquired thumbnail candidates.

The video data analysis part 209 ends the analysis of the video data in step S119, and the creation part 103 outputs the thumbnail candidates to the data recording part 1307 in step S405. The data recording part 1307 stores the thumbnail candidates to the storage part 1301 by associating the analyzed video data. The data recording part 1307 stores the thumbnail candidates to the storage part 1301 by associating the analyzed video data.

The processes in FIG. 18 are to conduct a video analysis process and the thumbnail candidate extraction process at the same time. The video analysis process may be first conducted, and after that, the thumbnail candidate extraction process may be conducted.

By the above-described processes, it is possible to store the information illustrated in FIG. 16 to the storage part 1301. According to the second embodiment, the thumbnail candidates are extracted based on the category of the video data. The user is allowed to select one of the extracted thumbnail candidates, so that the thumbnail data are defined.

In the second embodiment, the display control part 1308 controls a thumbnail display so as to change one of the multiple thumbnail candidate at predetermined intervals. This control may be effective in a case in which one of the multiple thumbnail candidates has not been selected by the user and the thumbnail display is performed.

### THIRD EMBODIMENT

Next, a video processing apparatus in a third embodiment will be described. In the third embodiment, by specifying and setting one scene to be thumbnail data for each category of video data, it is possible for a user to extract desired thumbnail data for each category. A hardware configuration of the video processing apparatus in the third embodiment may be the same as that in the first embodiment in FIG. 1.

### <Functions>

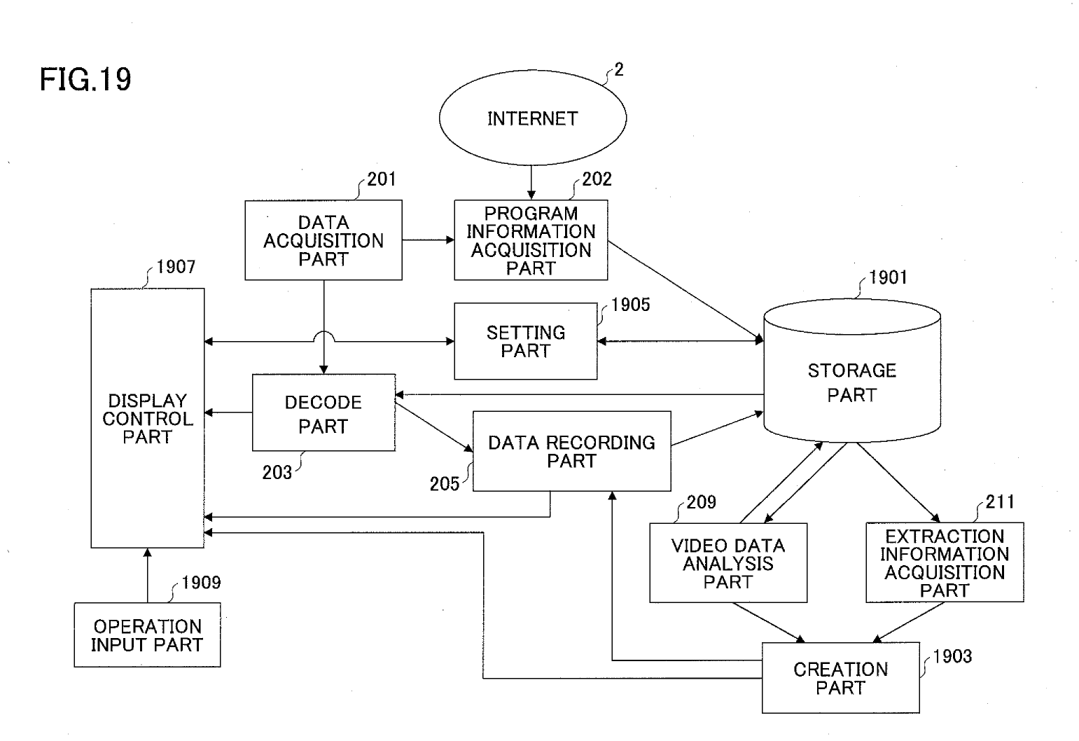

Next, functions of the video processing apparatus in the third embodiment will be described. FIG. 19 is a block diagram illustrating an example of a functional configuration of the video processing apparatus in the third embodiment. In the functional configuration illustrated in FIG. 19, functions that are the same as those illustrated in FIG. 2 are designated by the same reference numerals, and the description thereof is omitted.

The video processing apparatus illustrated in FIG. 19 includes a storage part 1901, a creation part 1903, a setting part 1905, a display control part 1907, and an operation input part 1909.

The storage part 1901 stores options of extraction information in the third embodiment. A “first scene of the video data”, a “first scene of a main program”, a “middle scene in the main program”, a “last scene of the main program”, and the like may be determined as the options of the extraction information. Moreover, a “first scene of themusic” may be considered.

When a display of a selection screen of the thumbnail data is request from an initial setting screen which is controlled and displayed by the display control part 1907, the setting part 1905 acquires the options of the extraction information stored in the storage part 1901. The setting part 1905 outputs the acquired options of the extraction information to the display control part 1907.

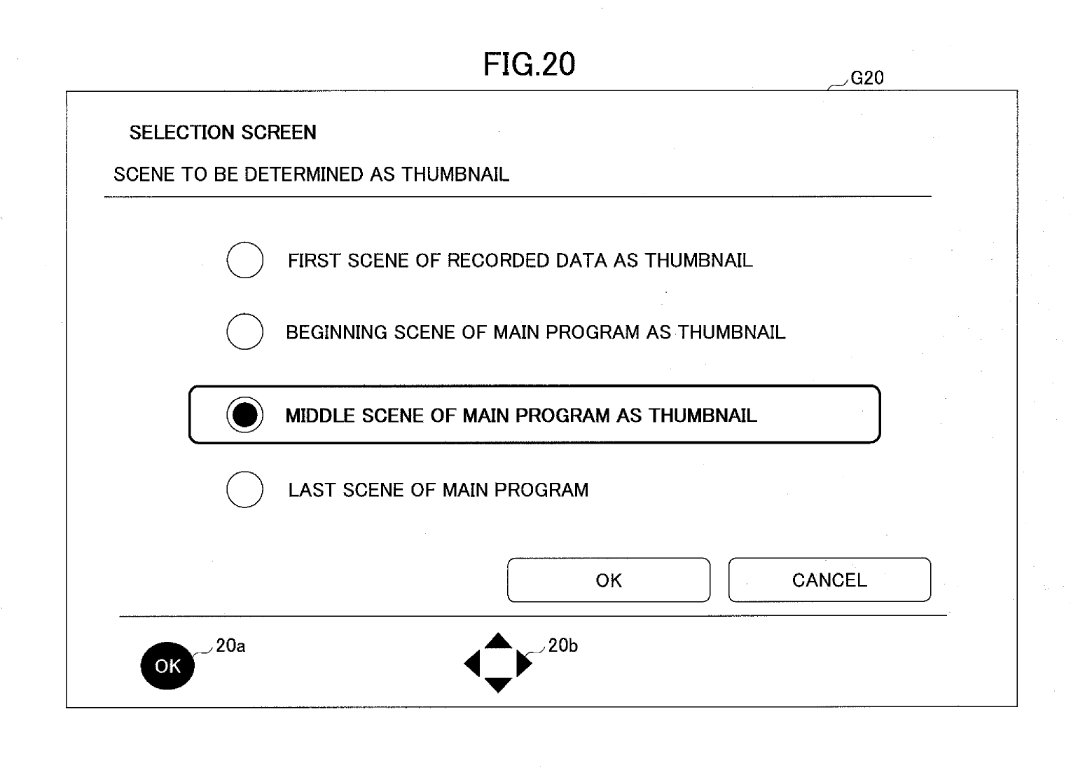

The display control part 1907 sends screen data of a screen in which one of the options of the extraction information acquired from the setting part 1905. FIG. 20 is a diagram illustrating an example of the selection screen of the thumbnail. As illustrated in FIG. 20, the options of the extraction information for extracting the thumbnail is displayed at a selection screen G20. The selection screen G20 in FIG. 20 displays a “FIRST SCENE OF RECORDED DATA”, a “BEGINNING SCENE OF MAIN PROGRAM AS THUMBNAIL”, a “MIDDLE SCENE OF MAIN PROGRAM AS THUMBNAIL”, and a “LAST SCENE OF MAIN PROGRAM”.

The beginning scene of the main program may be regarded as a beginning scene of the first main program. The middle scene of the main program may be regarded as a middle scene in all main programs. Also, the last scene of the main program may be regarded as a last scene of a last main program.

The user selects and defines a desired scene as the thumbnail by using a remote controller, the operation input part 1909 (which may be the function buttons of a main body) at the selection screen G20 illustrated in FIG. 20. When the display control part 1907 detects the extraction information in response to a determination signal from the remote controller or a selection by the user pressing an OK button 20a, the display control part 1907 reports the selected extraction information to the setting part 1905. Selection buttons 20b to up, down, right, and left may be used to select the desired scene.

The setting part 1905 records the reported extraction information to the storage part 1901 by associating the category of the predetermined video data. The above-described selection process of the thumbnail may be performed in an order which is defined beforehand for each category. Also, the selection process is not always conducted for all categories. For a category to which the selection process is not conducted, predetermined extraction information is set as a default.

The creation part 1903 extracts a portion from the video data by using the extraction information, which is previously selected by the user and acquired by the extraction information acquisition part 211, and creates the thumbnail data.

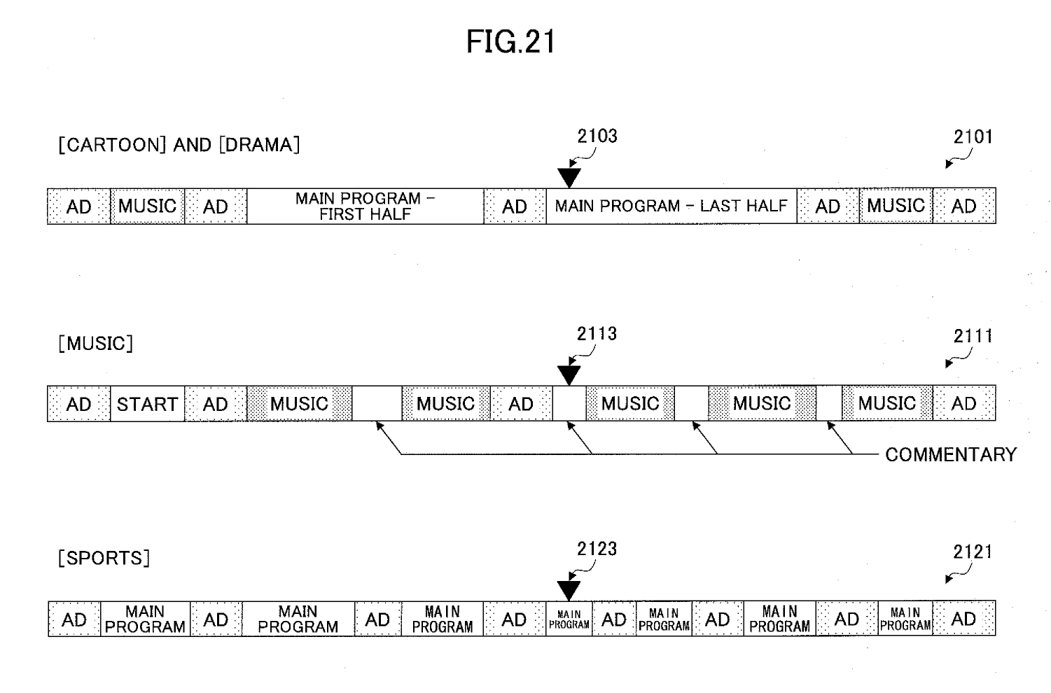

FIG. 21 is a diagram illustrating an example of extracted thumbnail data in the third embodiment. In FIG. 21, for convenience of explanation, the middle scene of the main program is selected as the thumbnail data beforehand for any category.

In the example in FIG. 21, the category of analyzed video data 2101 is the “CARTOON” or “DRAMA”. The creation part 1903 extracts the middle scene of the main program indicated by the extraction information, and creates the thumbnail data. A mark 2103 indicates a scene to be the thumbnail data. In a case in which the extraction information indicates the middle scene, it is preferable for the creation part 1903 to accumulate time of the main program sections of the analyzed video data, and to acquire a scene placed at middle of the main program.

The category of analyzed video data 2111 is the “MUSIC”. The creation part 1903 extracts the middle scene of the main program data indicated by the extraction information, and creates the thumbnail data. A mark 2113 indicates the scene to be the thumbnail data.

The category of analyzed video data 2121 is the “SPORTS”. The creation part 1903 extracts the middle scene of the main program data indicated by the extraction information, and creates the thumbnail data. A mark 2123 indicates the scene to be the thumbnail data.

The thumbnail data created by the creation part 1903 are recorded to the storage part 1901 by the data recording part 205 by associating the video data.

### <Operations>

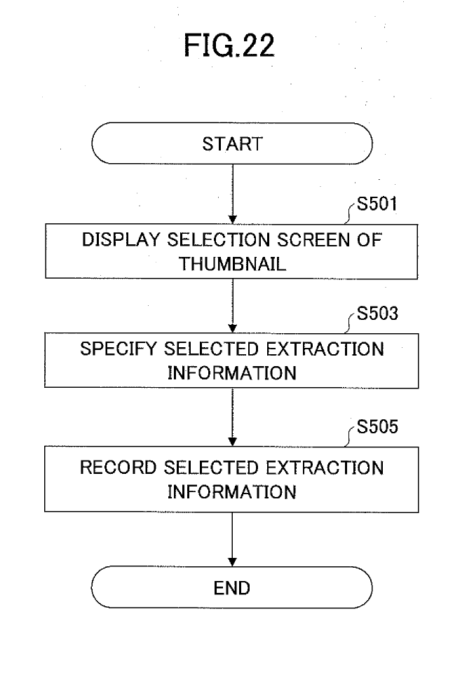

Next, operations of the video processing apparatus in the third embodiment will be described. FIG. 22 is a flowchart for explaining an example of a thumbnail selection process in the third embodiment. In step S501 in FIG. 22, the display control part 1907 sends screen data of selection screen G20 of the thumbnail to the display device 117, and displays the selection screen G20 of the thumbnail.

In step S503, the display control part 1907 specifies the extraction information which is selected by the user pressing the OK button 20a. The display control part 1907 reports the specified extraction information to the setting part 1905.

In step S505, the setting part 1905 records the reported extraction information to the storage part 1901 by associating the category of the predetermined video data.

Accordingly, by performing steps S501 to S505 for each category, it is possible for the user to set desired extraction information for each category beforehand.

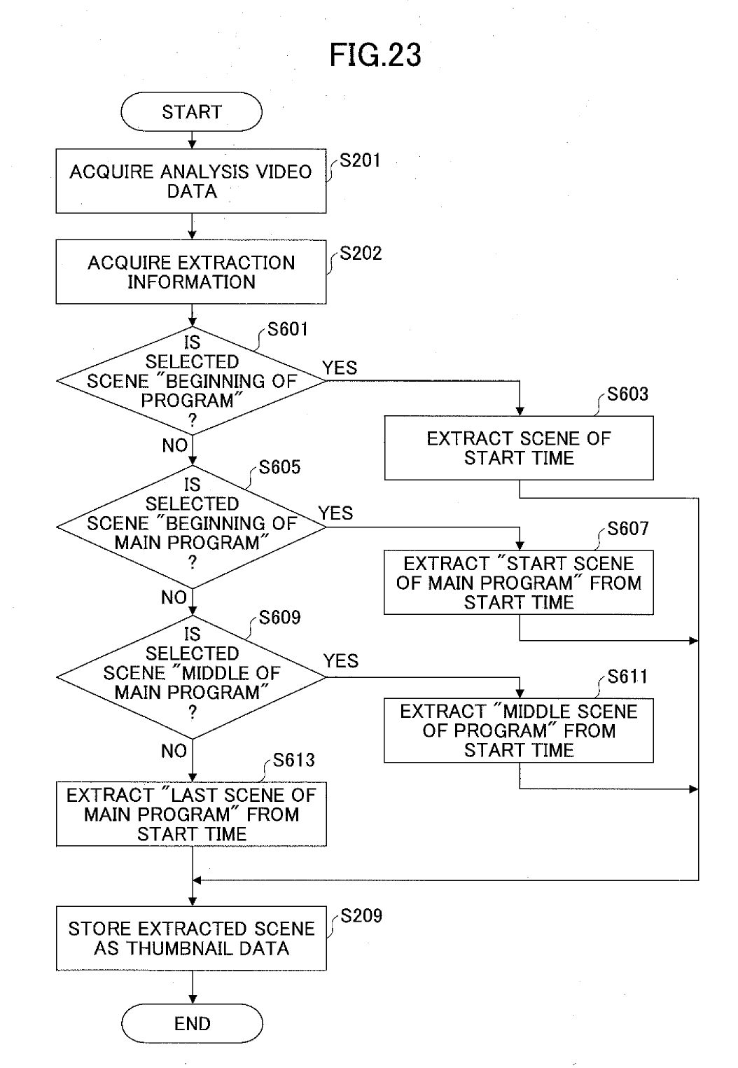

FIG. 23 is a flowchart for explaining an example of the thumbnail extraction process in the third embodiment. In the thumbnail extraction process illustrated in FIG. 23, steps that are the same as those illustrated in FIG. 11 are designated by the same reference numerals, and the description thereof is omitted.

In step S601 illustrated in FIG. 23, the creation part 1903 determines whether the extraction information, which is selected by the user and acquired from the extraction information acquisition part 211, indicates a ‘program beginning’. If a determination result indicates YES (the extraction information indicates the ‘program beginning’), the creation part 1903 advances to step S603. If the determination result indicates NO (the extraction information does not indicate the ‘program beginning’), the creation part 1903 advances to step S605.

In step S603, the creation part 1903 extracts the scene at the start time of the program, and creates the thumbnail data.

In step S605, the creation part 1903 determines whether the extraction information, which is selected by the user and acquired from the extraction information acquisition part 211, indicates a ‘beginning of the main program’. If a determination result indicates YES (the extraction information indicates the ‘beginning of the main program’), the creation part 1903 advances to step S607. If the determination result indicates NO (the extraction information does not indicate the ‘beginning of the main program’), the creation part 1903 advances to step S609.

In step S607, the creation part 1903 extracts the scene at the start time of the main program, and creates the thumbnail data.

In step S609, the creation part 1903 determines whether the extraction information, which is selected by the user and acquired from the extraction information acquisition part 211, indicates a ‘middle of the main program’. If a determination result indicates YES (the extraction information indicates the ‘middle of the main program’), the creation part 1903 advances to step S611. If the determination result indicates NO (the extraction information does not indicate the ‘middle of the main program’), the creation part 1903 advances to step S613.

In step S611, the creation part 1903 extracts the scene at time of the middle of the main program, and creates the thumbnail data.

In step S613, the creation part 1903 extracts the last scene of the main program, and creates the thumbnail data. In processes after that, the data recording part 205 records the extracted thumbnail data to the storage part 1901 by associating the video data.

Accordingly, in the third embodiment, by setting the scene to be the thumbnail data beforehand for each category of the video data, it is possible for the user to extract desired thumbnail data for each category.

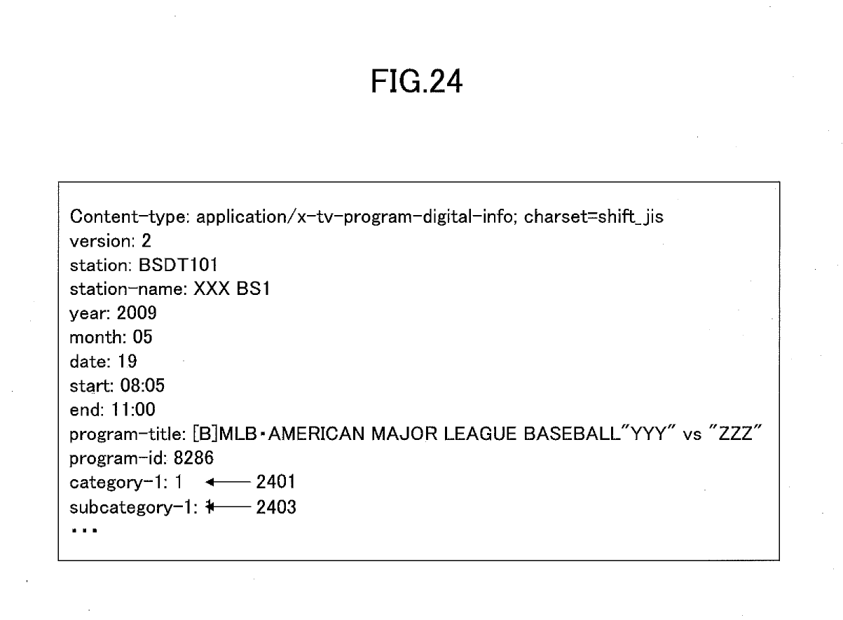

Next, a data structure of the EPG used in each of the above-described embodiments will be described. FIG. 24 is a diagram illustrating an example of the data structure of EPG. In FIG. 24, the data structure of the EPG is depicted as the example of the data structure of the EPG available to acquire through the Internet.

The EPG illustrated in FIG. 24 includes a major category “category-1” 2401, a middle category “subcategory-1” 2403, and the like. The major category “category-1” 2401 may indicates a major classification such as news, sports, drama, music, variety, or the like. The middle category “subcategory-1” 2403 may indicate a detailed classification such as weather, politics and economics, transportation, and the like in the news, baseball, soccer, golf, and the like in the sports, and the like.

Each of the categories indicated by numbers of the major category and the middle category is specified by a category table. In the category table, category names are corresponded to numbers of the major categories and numbers of the middle categories, respectively. In the example in FIG. 24, “1” of the “category-1” is corresponded to sports, “1” of the “subcategory-1” is corresponded to baseball.

The program information acquisition part 202 acquires EPG data illustrated in FIG. 24, and stores the acquired EPG data by associating the video data. In this case, the “category-1” and the “subcategory-1” may be used as category information. Also, the extraction information may be associated with the “category-1” and the “subcategory-1” as the category information. By this configuration, it is possible to use the category information acquired from the program information acquisition part 202 and the category information associated with the extraction information as the same type of category information.

According to the video processing apparatus in each of the above-described embodiment, it is possible to create the thumbnail data suitable for the user depending on the category of the video data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A video processing apparatus, comprising:
an acquisition part configured to acquire category information of video data of a process target;
a storage part configured to store each set of category information by associating extraction information indicating a location in a portion of the video data; and
a creation part configured to specify a location used for thumbnail data from the video data of the process target based on the extraction information, which is stored in the storage part and corresponds to the category information acquired by the acquisition part.

2. The video processing apparatus as claimed in claim 1, further comprising:
an analysis part configured to divide the video data into sections by analyzing the video data of the process target,
wherein the extraction information indicates a location in a divided section of the video data, and
the creation part creates the thumbnail data based on the location in the divided section, the location indicated by the extraction information in the video data analyzed by the analysis part.

3. The video processing apparatus as claimed in claim 2, wherein the storage part further stores a content configuration of the video data for each set of the category information,
the analysis part analyzes the video data based on the content configuration corresponding to the category information acquired by the acquisition part.

4. The video processing apparatus as claimed in claim 1, wherein the extraction information indicates multiple locations in the video data for each set of category information,
the creation part creates multiple thumbnail candidates based on the multiple locations indicated by the extraction information, from the video data of the process target, and further includes
a selection part configured to select one of the multiple thumbnail candidates which are created.

5. The video processing apparatus as claimed in claim 1, further comprising:
a setting part configured to set one of multiple sets of the extraction information,
wherein the storage part stores the multiple sets of the extraction information for each set of the category information, and
the creation part creates the thumbnail data from the video data of the process target based on the extraction information which is set by the setting part.

6. A video processing method performed in a video processing apparatus including a computer and a storage part, the method comprising:
acquiring, by the computer, category information of video data of a process target; and
specifying, by the computer, a location used for thumbnail data from the video data of a process target based on extraction information corresponding to the category information which is acquired from the extraction information indicating a location in a portion of the video data stored in the storage part by associating the category information of the video data.

7. A non-transitory computer-readable recording medium stored therein a program for causing a computer to execute a video process comprising:
acquiring category information of video data of a process target; and
specifying a location used for thumbnail data from the video data of the process target based on extraction information corresponding to the category information which is acquired from the extraction information indicating a location in a portion of the video data stored in a storage part by associating the category information of the video data.
